(19) United States
(12) Patent Application Publication
(10) Pub. No.: US 2023/0126575 A1
(43) Pub. Date: Apr. 27, 2023

(54) SELECTING A BOOTSTRAP PROFILE FROM A GROUP OF BOOTSTRAP PROFILES THAT HAVE BEEN STORED IN A WIRELESS DEVICE FOR BOOTSTRAPPING OF THE WIRELESS DEVICE

(71) Applicant: AT&T Intellectual Property I, L.P., Atlanta, GA (US)

(72) Inventors: Jack Owen Adair, Marietta, GA (US); Jason Sikes, Carnation, WA (US)

(21) Appl. No.: 17/512,663

(22) Filed: Oct. 27, 2021

(51) Int. Cl. H04W 8/20; H04W 12/40; H04W 76/12; H04W 76/18

(52) U.S. Cl. CPC H04W 8/20; H04W 12/40; H04W 76/12; H04W 76/18

(57) ABSTRACT

Selecting a provisioning profile from a group of distinct provisioning profiles that have been stored in a mobile device for bootstrapping of the mobile device is presented herein. A system generates a group of a defined number of different provisioning profiles; stores the group of the defined number of different provisioning profiles in a data storage device that is part of a network; sends the group of the defined number of different provisioning profiles to a device manufacturer device corresponding to a device manufacturer to facilitate storage of the group of the defined number of different provisioning profiles in mobile devices including the mobile device; and based on a selection of a provisioning profile from the group of the defined number of different provisioning profiles that has been stored in the mobile device, enables an access, by the mobile device, of a network service of the network.

### TECHNICAL FIELD

The subject disclosure generally relates to embodiments for selecting a bootstrap profile from a group of bootstrap profiles that have been stored in a wireless device for bootstrapping of the wireless device.

### BACKGROUND

A conventional wireless device supporting embedded subscriber identification module (eSIM) technology is required to have wireless access, e.g., WiFi access, to download, via bootstrapping of the wireless device, a bootstrap profile into an eSIM of the wireless device. The bootstrap profile is a unique provisioning profile enabling limited, or controlled, wireless network access related to downloading of a user's operational profile onto the wireless device—such profile specifying information required for the wireless device to utilize wireless service(s) of the wireless network, e.g., based on a subscription, user plan, policy, etc.

Unfortunately, wireless access is not guaranteed, and bootstrapping (or loading) of the bootstrap profile into the eSIM cannot be performed without the wireless access. Consequently, eSIM technologies have had some drawbacks, some of which are noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a communication environment including a bootstrap network system for facilitating a selection of a provisioning profile from a group of a defined number of different provisioning profiles that have been stored in a mobile device for bootstrapping of the mobile device, in accordance with various example embodiments;

FIG. 2 illustrates a block diagram of a bootstrap network system for facilitating a selection of a provisioning profile from a group of a defined number of different provisioning profiles that have been stored in a mobile device for bootstrapping of the mobile device, in accordance with various example embodiments;

FIG. 3 illustrates a block diagram of a bootstrap profile component of a bootstrap network system, in accordance with various example embodiments;

FIG. 4 illustrates a block diagram of a mobile device that selects a provisioning profile from a group of a defined number of different provisioning profiles that have been stored in a memory of the mobile device for bootstrapping of the mobile device, in accordance with various example embodiments, in accordance with various example embodiments;

FIG. 5 illustrates a flow chart of a method associated with facilitating a selection of a provisioning profile from a group of a defined number of different provisioning profiles that have been stored in a mobile device for bootstrapping of the mobile device, in accordance with various example embodiments;

FIGS. 6-8 illustrate flow charts of a method associated with receiving an attach request from a mobile device corresponding to a selection of a provisioning profile from a group of a defined number of different provisioning profiles that have been stored in the mobile device for bootstrapping of the mobile device, in accordance with various example embodiments;

FIG. 9 illustrates a flow chart of a method performed by a mobile device for facilitating a selection of a provisioning profile from a group of a defined number of different provisioning profiles that have been stored in the mobile device for bootstrapping of the mobile device, in accordance with various example embodiments;

FIG. 10 illustrates a flow chart of a method performed by a mobile device associated with receiving a rejection of an attach request from a bootstrap network system, the method associated with randomly selecting another provisioning profile from a group of a defined number of different provisioning profiles that have been stored in the mobile device for bootstrapping of the mobile device, in accordance with various example embodiments;

FIG. 11 illustrates a flow chart of a method performed by a mobile device associated with receiving a rejection of an attach request from a bootstrap network system, the method associated with reselecting, after a defined processing delay has been performed by the mobile device, a provisioning profile from a group of a defined number of different provisioning profiles that have been stored in the mobile device for bootstrapping of the mobile device, in accordance with various example embodiments; and

FIG. 12 is a block diagram representing an illustrative non-limiting computing system or operating environment in which one or more aspects of various embodiments described herein can be implemented for facilitating a selection of a provisioning profile from a group of a defined number of different provisioning profiles that have been stored in a mobile device for bootstrapping of the mobile device, in accordance with various example embodiments.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional bootstrapping technologies have had some drawbacks with respect to not being able to load, via bootstrapping, a bootstrap profile into an eSIM of a mobile device due to lack of wireless service. On the other hand, various embodiments disclosed herein can facilitate improved cellular subscriber experiences by storing a group of a defined number of different provisioning profiles in a mobile device, and facilitating a selection, by the mobile device, of a provisioning profile from the group of the defined number of different provisioning profiles for bootstrapping of the mobile device.

For example, in embodiment(s), a system comprises a processor and a memory that stores executable instructions that, when executed by the processor, facilitate performance of operations by the processor—the operations comprising: generating a group of a defined number of different provisioning profiles, e.g., bootstrap profiles, that facilitate respective accesses, via respective mobile devices, of network services that have been enabled via a network, e.g., a bootstrap network, associated with a network service provider (e.g., wireless carrier)—the different provisioning profiles comprising respective international mobile subscriber identities (IMSIs) and respective authentication information, e.g., security key(s), or other similar data that enable the respective accesses of the network services by respective subscribers of the network services.

Further, the operations comprise: storing, as a stored group of the defined number of different provisioning profiles, the group of the defined number of different provisioning profiles in a data storage device that is part of the network; and sending the group of the defined number of different provisioning profiles to a device manufacturer device corresponding to a device manufacturer to facilitate storage of the group of the defined number of different provisioning profiles in the respective mobile devices, e.g., to facilitate respective accesses, via the respective mobile devices, of the group of the defined number of different provisioning profiles.

In turn, based on a selection, by a mobile device of the respective mobile devices, of a provisioning profile from the group of the defined number of different provisioning profiles that has been stored in a memory of the mobile device, the operations further comprise: enabling, e.g., via bootstrapping of the mobile device using the provisioning profile, an access of the respective accesses of the network services by the mobile device.

In this regard, in embodiment(s), the mobile device selects, via an operating system (OS) of the mobile device, the provisioning profile from a memory of the mobile device, and stores, via bootstrapping of the mobile device, the provisioning profile in an eSIM, e.g., included in an embedded universal integrated circuit card (eUICC), of the mobile device to facilitate the access by the mobile device.

In other embodiment(s), a method comprises: storing, by a mobile device comprising a processor, a group of a defined number of different provisioning profiles, e.g., bootstrap profiles, in a memory device of the mobile device—the different provisioning profiles comprising respective IMSIs and respective authentication information, and the different provisioning profiles facilitating respective accesses, via respective mobile devices comprising the mobile device, of network services that have been enabled via a network, e.g., a bootstrap network, associated with a network service provider.

Further, the method comprises: selecting, by the mobile device via an OS of the mobile device, a provisioning profile from the group of the defined number of different provisioning profiles that has been stored in the memory device of the mobile device; storing (or bootstrapping) by the mobile device, the selected provisioning profile in an eSIM of the mobile device (e.g., the eSIM being included in an eUICC of the mobile device); and sending, by the mobile device via the eSIM, an attach request comprising the provisioning profile to a bootstrap network system of the network associated with the network service provider.

In turn, in response to the attach request being accepted by the bootstrap network system, the method further comprises: receiving, by the mobile device from the bootstrap network system, an operational profile to facilitate, based on the operational profile, an access of the respective accesses of the network services by the mobile device.

In yet other embodiment(s), a non-transitory machine-readable medium, comprises executable instructions that, when executed by a system comprising a processor, facilitate performance of operations, comprising: generating a group of distinct provisioning profiles that facilitate respective accesses, via respective mobile devices, of network services that have been enabled via network equipment that is part of a network, e.g., a bootstrap network; storing the group of distinct provisioning profiles in a data storage device that is part of the network; and sending, via an allocation to a device manufacturer, the group of distinct provisioning profiles to a device manufacturer device corresponding to the device manufacturer, in which the group of distinct provisioning profiles has been stored, based on the allocation to the device manufacturer, in the respective mobile devices to facilitate—based on a selection, by a mobile device of the respective mobile devices, of a provisioning profile from the group of distinct provisioning profiles that has been stored in the mobile device—an access of the respective access of the network services, enabled via the network, by the mobile device.

Reference throughout this specification to “one embodiment,” “an embodiment,” etc. means that a particular feature, structure, or characteristic described in connection with the embodiment is included in at least one embodiment. Thus, the appearances of the phrase “in one embodiment,” “in an embodiment,” etc. in various places throughout this specification are not necessarily all referring to the same embodiment. Furthermore, the particular features, structures, or characteristics may be combined in any suitable manner in one or more embodiments.

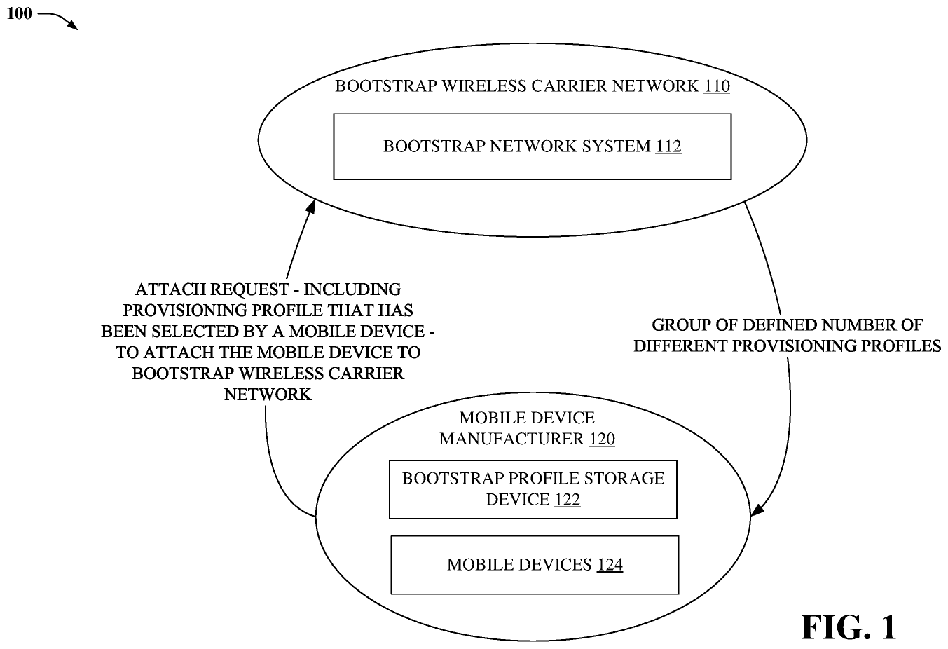

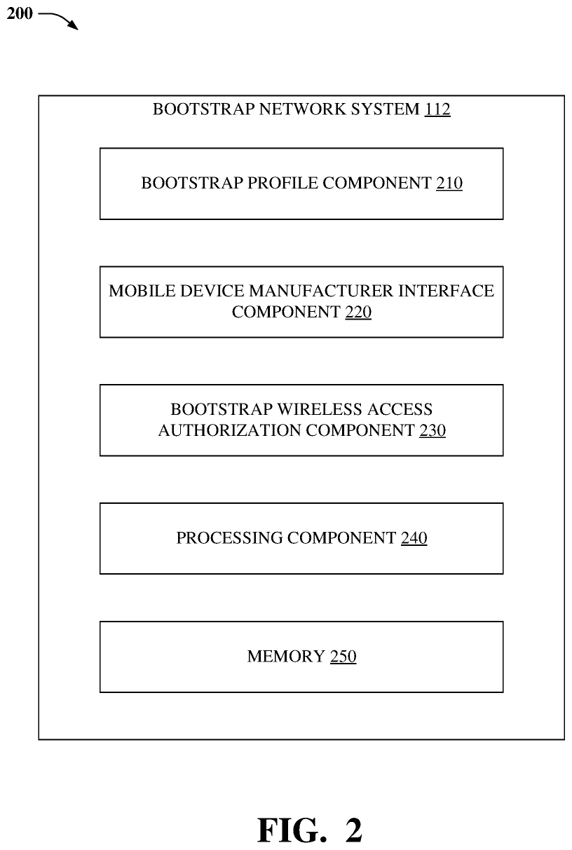

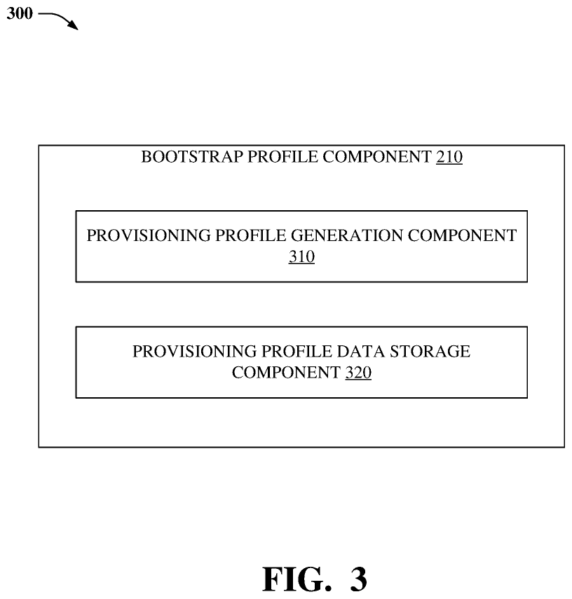

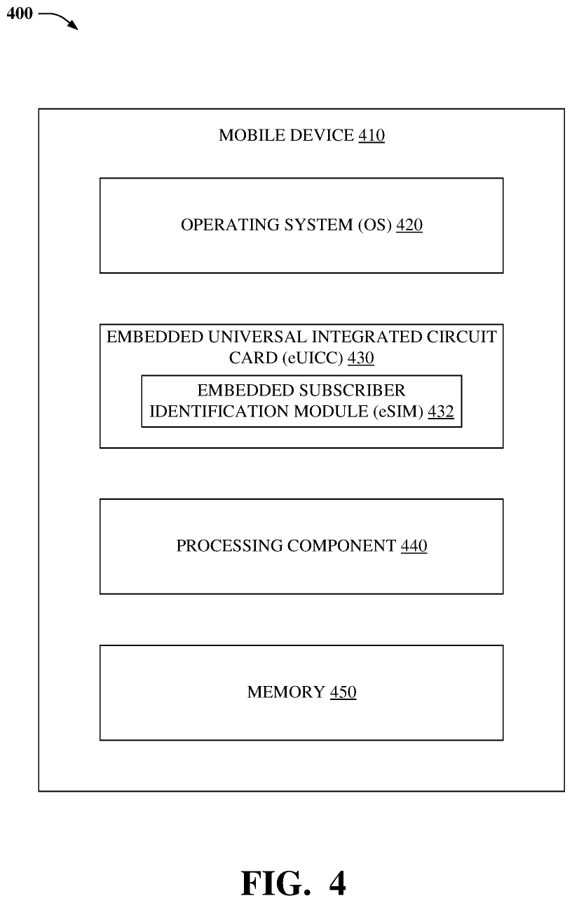

Referring now to FIGS. 1-4, a bootstrap network system (112) can enable cellular service without requiring wireless, e.g., WiFi, access for downloading, e.g., bootstrapping, of a bootstrap profile into an eSIM of a wireless device. The bootstrap network system includes a bootstrap profile component (210), a mobile device manufacturer interface component (220), a bootstrap wireless access authorization component (230), a processing component (240), and a memory (250).

The bootstrap profile component includes a provisioning profile generation component (310) and a provisioning profile data storage component (320). The provisioning profile generation component generates a group of a defined number of different provisioning profiles corresponding to respective mobile devices (124)— the different provisioning profiles facilitating respective accesses, via the respective mobile devices, of network services enabled via a network, e.g., a bootstrap network (e.g., bootstrap wireless carrier network (110)), associated with a network service provider (e.g., a wireless carrier).

In this regard, as the provisioning profile generation component increases the defined number of different provisioning profiles that are generated, a selection of a provisioning profile from the group of the defined number of different provisioning profiles becomes more arbitrary, e.g., the randomness of the selection increases, e.g., reducing the probability that the selected provisioning profile is currently being used by another mobile device to attach to the network.

The provisioning profile generation component further stores, via the provisioning profile data storage component, the group of the defined number of different provisioning profiles (as a stored group of the defined number of different provisioning profiles) in data storage device(s) (e.g., of the provisioning profile data storage component) that are part of the network associated with the network service provider.

The mobile device manufacturer interface component sends the group of the defined number of different provisioning profiles to a device manufacturer device (not shown) corresponding to a mobile device manufacturer (120) to facilitate storage of the group of the defined number of different provisioning profiles in the respective mobile devices.

In turn, the mobile device manufacturer stores the respective provisioning profiles in a bootstrap profile storage device (122), and installs, e.g., via the bootstrap profile storage device, the respective provisioning profiles in respective memories (e.g., 450) (e.g., non-volatile memories) of the respective mobile devices (e.g., 410), e.g., during manufacture of the respective mobile devices, and/or as part of respective software installations of the respective mobile devices.

In this regard, the group of the defined number of different provisioning profiles is loaded into every mobile device of the respective mobile devices to facilitate respective accesses, by the respective mobile devices, of the network services enabled via the network associated with the network service provider, e.g., without requiring respective downloads of provisioning profiles into the respective mobile devices utilizing WiFi and/or other wireless interface(s).

In embodiment(s), a processing component (440) (e.g., including processor(s)) of a mobile device (410) of the respective mobile devices can select, via an OS (420) of the mobile device, a provisioning profile from the group of the defined number of different provisioning profiles that has been stored in a memory (450) of the mobile device to facilitate an access of the respective accesses of the network services by the mobile device.

In this regard, in embodiment(s), the processing component can randomly, or arbitrarily, select, via the OS of the mobile device, the provisioning profile from the group of the defined number of different provisioning profiles that has been stored in the memory of the mobile device. Further, the processing component can store, e.g., via bootstrapping, the selected provisioning profile in an eSIM (432) of an eUICC (430) of the mobile device.

In embodiments, the provisioning profile comprises an international mobile subscriber identity (IMSI) and authentication information, e.g., security key(s), or other similar data that enables authorization of the access by the mobile device, e.g., by a subscriber of a network service enabled via the network. An IMSI is a unique number, e.g. unique IMSI number, which mobile network operators use to recognize a mobile device corresponding to the subscriber of the network service.

The mobile device can send, to the bootstrap network system via the eSIM, an attach request to attach to the network—the attach request comprising the provisioning profile—to facilitate the access of the respective access of the network services by the mobile device.

In turn, in response to the bootstrap network system matching the provisioning profile with a stored provisioning profiles that has been stored in the data storage device of the network, and in response to the bootstrap network system determining that another mobile device that is different from the mobile device is not being attached to the network profile of the stored group of the defined number of the different provisioning using the provisioning profile, the bootstrap network system accepts and/or authorizes the attach request—enabling, using the provisioning profile, the access.

In this regard, in embodiment(s), the bootstrap network system enables the access by sending an operational profile to the mobile device to be downloaded into the eSIM of the mobile device to facilitate, based on the operational profile, the access of the respective accesses of the network services by the mobile device. In embodiment(s), the operational profile comprises a country code, a network operator code representing the network operator, a mobile device number of the mobile device, and a key corresponding to a unique IMSI number that is used to enable the access, by the mobile device, of network, e.g., wireless, service(s) enabled via the network associated with the network service provider.

In embodiment(s), in response to the bootstrap network system rejecting the attach request, e.g., in response to the bootstrap network system determining that the provisioning profile does not match a stored provisioning profile of the stored group of the defined number of the different provisioning profiles that has been stored in the data storage device of the network, or in response to the bootstrap network system determining that another mobile device is being attached to the network using the provisioning profile, the mobile device, via the processing component, can randomly, or arbitrarily, select, via the OS of the mobile device, another provisioning profile (e.g., other provisioning profile) from the group of the defined number of different provisioning profiles that has been stored in the memory of the mobile device. Further, the mobile device, via the processing component, can store, e.g., via bootstrapping, the other provisioning profile in the eSIM of the eUICC of the mobile device.

In turn, the mobile device can send, to the bootstrap network system via the eSIM, another attach request (e.g., other attach request) to attach to the network—the other attach request comprising the other provisioning profile to facilitate the access of the respective access of the network services by the mobile device.

In embodiment(s), the bootstrap network system temporarily, e.g., for a defined period of time (e.g., less than ½ sec), utilizes (or employs) a bootstrap profile that has been included in an attach request that has been received from the mobile device to process (e.g., accept or reject) the attach request, and to enable the access of the network services, e.g., by facilitating storage, using the provisioning profile, of the operational profile in the eSIM of the mobile device.

In this regard, in embodiment(s), in response to determining that the bootstrap network system has rejected an attach request (e.g., a first attach request) comprising a provisioning profile, the mobile device can perform, via the processing component, a defined delay, e.g., suspend processing of the mobile device for the defined delay, e.g., the defined delay being greater than the defined period of time in which the bootstrap network system processes the first attach request and facilitates the storage, using the provisional profile, of the operational profile in the eSIM of the mobile device.

Further, the mobile device can reselect, after the defined delay has been performed, the provisioning profile (e.g., a reselected provisioning profile). In turn, the mobile device can send, to the bootstrap network system via the eSIM, a second attach request to attach to the network—the second attach request comprising the reselected provisioning profile to facilitate the access of the respective access of the network services by the mobile device.

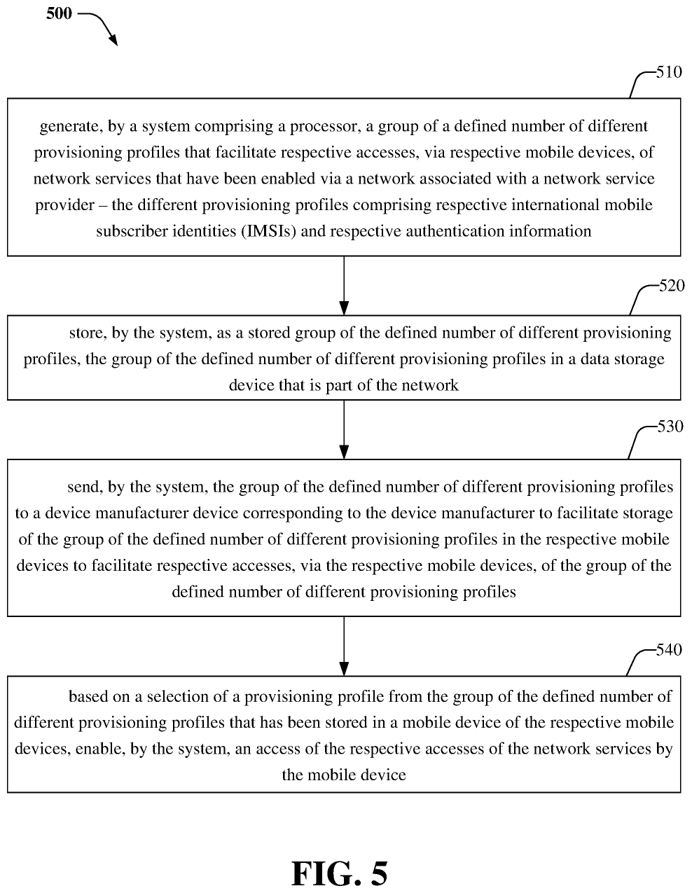

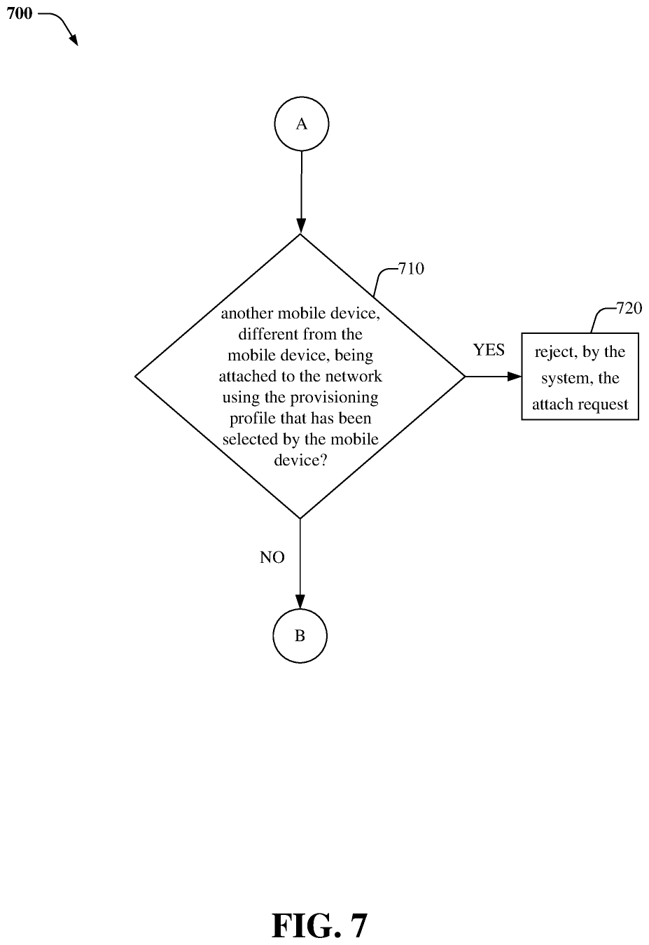

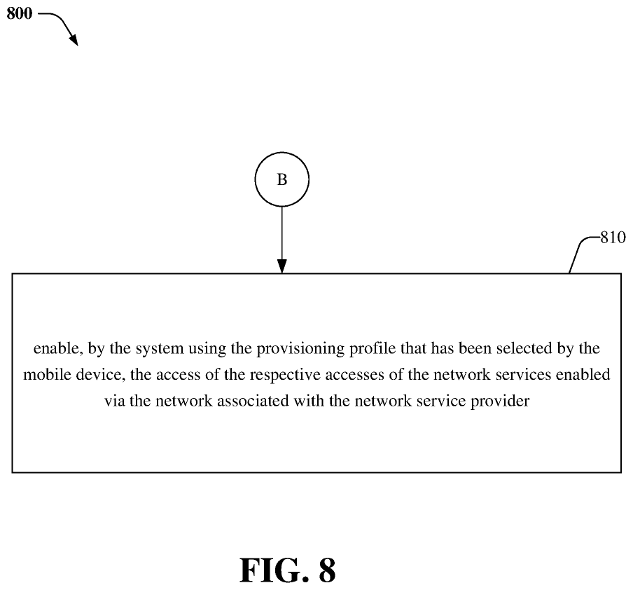

FIGS. 5-11 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 5, a flow chart (500) of a method associated with facilitating a selection of a provisioning profile from a group of a defined number of different provisioning profiles that have been stored in a mobile device (410) for bootstrapping of the mobile device is illustrated, in accordance with various example embodiments.

At 510, a system (e.g., 112) generates a group of a defined number of different provisioning profiles that facilitate respective accesses, via respective mobile devices, of network services that have been enabled via a network associated with a network service provider—the different provisioning profiles comprising respective IMSIs and respective authentication information.

At 520, the system stores, as a stored group of the defined number of different provisioning profiles, the group of the defined number of different provisioning profiles in a data storage device that is part of the network.

At 530, the system sends the group of the defined number of different provisioning profiles to a device manufacturer device corresponding to the device manufacturer to facilitate storage of the group of the defined number of different provisioning profiles in the respective mobile devices to facilitate respective accesses, via the respective mobile devices, of the group of the defined number of different provisioning profiles.

At 540, based on a selection of a provisioning profile from the group of the defined number of different provisioning profiles that has been stored in a mobile device of the respective mobile devices, the system enables an access of the respective accesses of the network services by the mobile device.

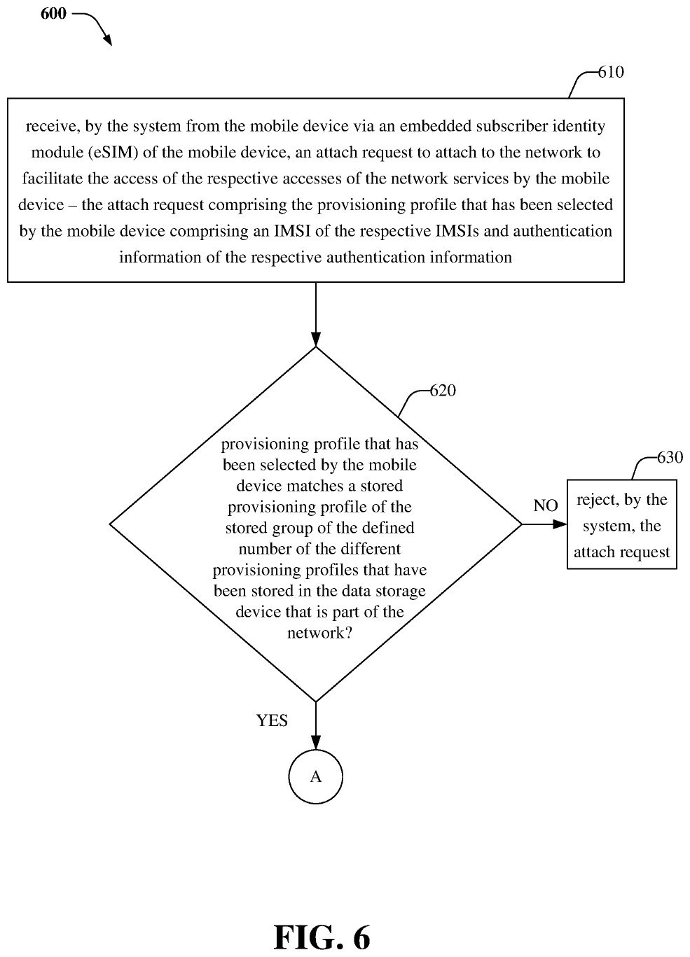

In this regard, and now referring to FIG. 6, at 610, the system receives, from the mobile device via an eSIM of the mobile device, an attach request to attach to the network to facilitate the access of the respective accesses of the network services by the mobile device—the attach request comprising the provisioning profile that has been selected by the mobile device comprising an IMSI of the respective IMSIs and authentication information of the respective authentication information.

In turn, at 620, the system can determine whether the provisioning profile that has been selected by the mobile device matches a stored provisioning profile of the stored group of the defined number of the different provisioning profiles that has been stored in the data storage device that is part of the network.

In this regard, in response to determining that the provisioning profile that has been selected by the mobile device matches a stored provisioning profile that has been stored in the data storage device that is part of the network, flow continues to 710, at which the system determines whether another mobile device, different from the mobile device, is attached to the network using the provisioning profile that has been selected by the mobile device; otherwise flow continues to 630, at which the system rejects the attach request.

At 710, in response to determining that another mobile device, different from the mobile device, is attached to the network using the provisioning profile that has been selected by the mobile device, flow continues to 720, at which the system rejects the attach request; otherwise flow continues to 810, at which the system enables, using the provisioning profile that has been selected by the mobile device, the access of the respective accesses of the network services enabled via the network associated with the network service provider.

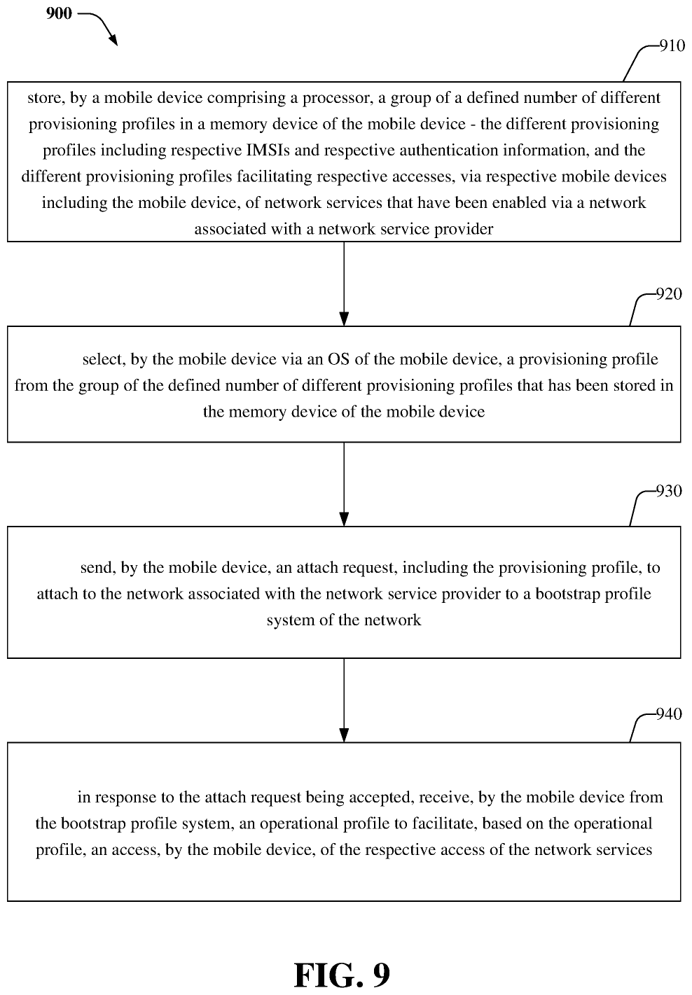

FIG. 9 illustrates a flow chart (900) of a method performed by a mobile device (410) for facilitating a selection of a provisioning profile from a group of a defined number of different provisioning profiles that have been stored in the mobile device for bootstrapping of the mobile device, in accordance with various example embodiments.

At 910, the mobile device stores a group of a defined number of different provisioning profiles in a memory device of the mobile device—the different provisioning profiles including respective IMSIs and respective authentication information, and the different provisioning profiles facilitating respective accesses, via respective mobile devices including the mobile device, of network services that have been enabled via a network associated with a network service provider.

At 920, the mobile device selects, e.g., randomly/arbitrarily, via an OS of the mobile device, a provisioning profile from the group of the defined number of different provisioning profiles that has been stored in the memory device of the mobile device.

At 930, the mobile device sends an attach request, including the provisioning profile, to attach to the network associated with the network service provider to a bootstrap network system (112) of the network.

At 940, in response to the attach request being accepted, the mobile device receives, from the bootstrap network system, an operational profile to facilitate, based on the operational profile, an access, by the mobile device, of the respective access of the network services.

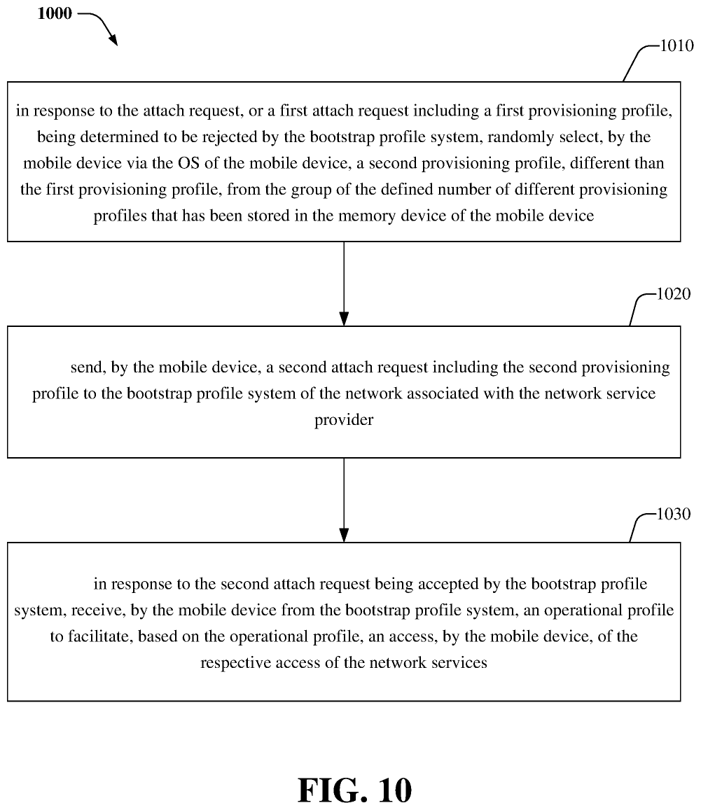

FIG. 10 illustrates a flow chart (1000) of a method performed by a mobile device (410) associated with receiving a rejection of an attach request from a bootstrap network system (112), the method associated with randomly selecting another provisioning profile from a group of a defined number of different provisioning profiles that have been stored in the mobile device for bootstrapping of the mobile device, in accordance with various example embodiments;

At 1010, in response to the attach request, or a first attach request including a first provisioning profile, being determined to be rejected by the bootstrap network system, the mobile device randomly selects, via the OS of the mobile device, a second provisioning profile, different than the first provisioning profile, from the group of the defined number of different provisioning profiles that has been stored in the memory device of the mobile device.

At 1020, the mobile device sends a second attach request including the second provisioning profile to the bootstrap network system of the network associated with the network service provider.

At 1030, in response to the second attach request being accepted by the bootstrap network system, the mobile device receives, from the bootstrap network system, an operational profile to facilitate, based on the operational profile, an access, by the mobile device, of the respective access of the network services

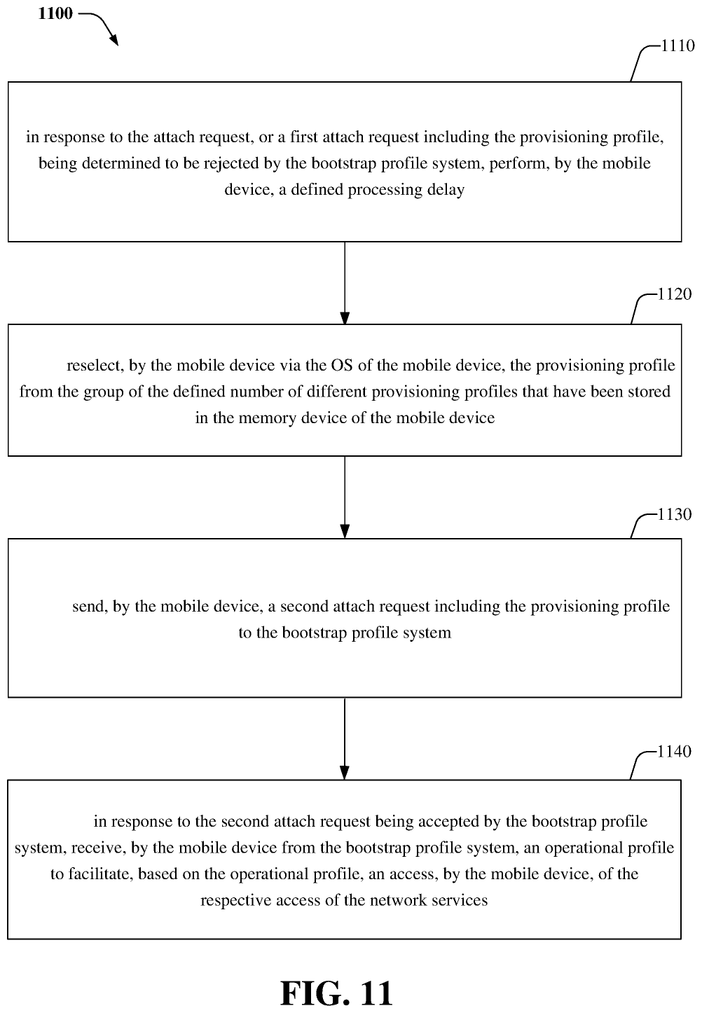

FIG. 11 illustrates a flow chart (1100) of a method performed by a mobile device (410) associated with receiving a rejection of an attach request from a bootstrap network system, the method associated with reselecting, after a defined processing delay has been performed by the mobile device, a provisioning profile from a group of a defined number of different provisioning profiles that have been stored in the mobile device for bootstrapping of the mobile device, in accordance with various example embodiments.

At 1110, in response to the attach request, or a first attach request including the provisioning profile, being determined to be rejected by the bootstrap network system, the mobile device performs a defined processing delay.

At 1120, after the defined processing delay has been performed, the mobile device reselects, via the OS of the mobile device, the provisioning profile from the group of the defined number of different provisioning profiles that have been stored in the memory device of the mobile device.

At 1130, the mobile device, sends a second attach request including the provisioning profile to the bootstrap network system.

At 1140, in response to the second attach request being accepted by the bootstrap network system, the mobile device receives, from the bootstrap network system, an operational profile to facilitate, based on the operational profile, an access, by the mobile device, of the respective access of the network services.

As it employed in the subject specification, the term “processor”, “processing component”, or other terms referencing a processing device can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “memory component”, “memory”, “memory storage”, “system memory”, “data storage”, “storage device”, and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in bootstrap network system 112, bootstrap profile storage device 122, mobile devices 124, memory 250, provisioning profile data storage component 320, mobile device 410, memory 450, system memory 1206 (see below), external storage 1216 (see below), and/or memory storage 1252 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1212) can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

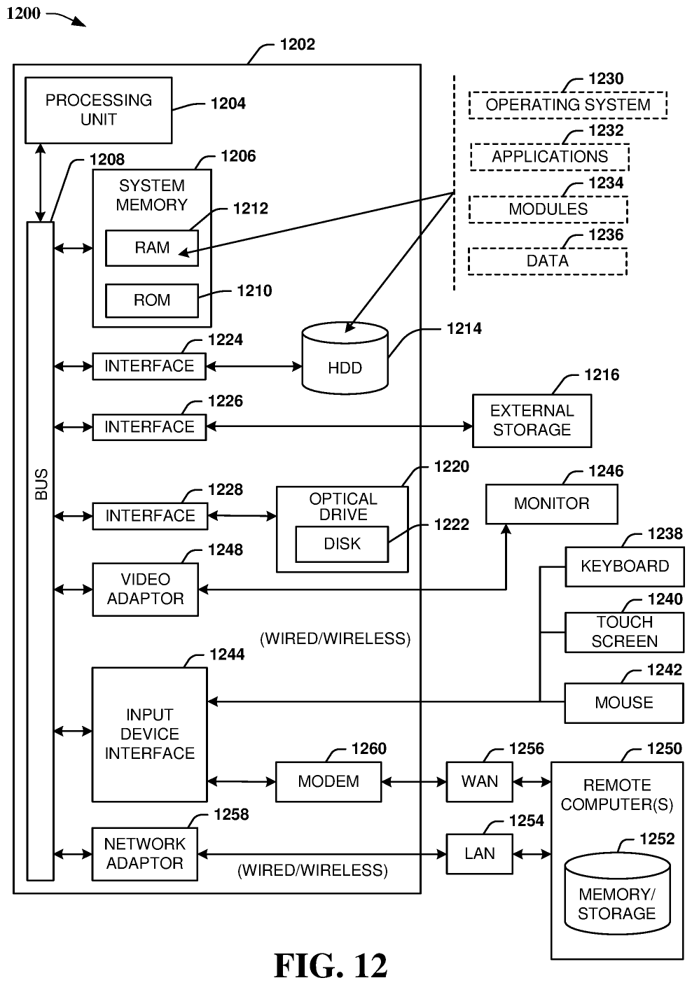

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that in various embodiments, methods disclosed herein can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment, e.g., a bootstrap network, using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As utilized herein, terms “component,” “system,” “server,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a bootstrap network, and/or other corresponding networks, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Further, aspects, features, and/or advantages of the disclosed subject matter can be exploited in substantially any wireless telecommunication or radio technology, e.g., IEEE 802.XX technology, e.g., Wi-Fi, Bluetooth, etc.; WiMAX; enhanced GPRS; 3GPP LTE; 3GPP2; UMB; 3GPP UMTS; HSPA; high speed downlink packet access (HSDPA); high speed uplink packet access (HSUPA); LTE-A, GSM, NFC, Wibree, Zigbee, satellite, Wi-Fi Direct, etc.

In addition, selections of a radio technology, or radio access technology, can include second generation (2G), third generation (3G), fourth generation (4G), fifth generation (5G), x^{th} generation, etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, and/or within one or more elements of a network infrastructure, e.g., radio network controller, wireless access point (AP), RAN equipment, etc.

Moreover, terms like “mobile device,” “user equipment,” (UE) “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication environment, e.g., 100, for systems, methods, and/or apparatus disclosed herein can include any suitable mobile and/or wireline-based circuit-switched communication network including a GSM network, a time division multiple access (TDMA) network, a code division multiple access (CDMA) network, such as an Interim Standard 95 (IS-95) and subsequent iterations of CDMA technology, an integrated digital enhanced network (iDEN) network and a PSTN. Further, examples of the communication network can include any suitable data packet-switched or combination data packet/circuit-switched communication network, wired or wireless IP network such as a VoLTE network, a VoIP network, an IP data network, a UMTS network, a GPRS network, or other communication networks, e.g., a bootstrap network, that provide streaming data communication over IP and/or integrated voice and data communication over combination data packet/circuit-switched technologies.

Similarly, one of ordinary skill in the art will appreciate that a wireless device, e.g., a wireless communication device, a user equipment, etc. for systems, methods, and/or apparatus disclosed herein can include a mobile device, a mobile phone, a 4G, a 5G, etc. cellular communication device, a PSTN phone, a cellular communication device, a cellular phone, a satellite communication device, a satellite phone, a VoIP phone, WiFi phone, a dual-mode cellular/WiFi phone, a combination cellular/VoIP/WiFi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/WiFi device, such as a dual-mode GSM, TDMA, IS-95 and/or iDEN/VoIP phones, UMTS phones, UMTS VoIP phones, or like devices or combinations thereof.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various aspects of the subject specification, artificial intelligence based systems, components, etc. can employ classifier(s) that are explicitly trained, e.g., via a generic training data, as well as implicitly trained, e.g., via observing characteristics of communication equipment, e.g., a gateway, a wireless communication device, etc., by receiving reports from such communication equipment, by receiving operator preferences, by receiving historical information, by receiving extrinsic information, etc.

For example, support vector machines can be configured via a learning or training phase within a classifier constructor and feature selection module, component, etc. Thus, the classifier(s) can be used by an artificial intelligence system to automatically learn and perform a number of functions, e.g., performed by a system (e.g., 112), including, but not limited to, generating a group of a defined number of different provisioning profiles that facilitate respective accesses, via respective mobile devices, of network services that have been enabled via a network, e.g., a bootstrap network, associated with a network service provider, wherein the different provisioning profiles comprise respective international mobile subscriber identities and respective authentication information; storing, as a stored group of the defined number of different provisioning profiles, the group of the defined number of different provisioning profiles in a data storage device that is part of the network; sending the group of the defined number of different provisioning profiles to a device manufacturer device corresponding to a device manufacturer to facilitate storage of the group of the defined number of different provisioning profiles in the respective mobile devices to facilitate respective accesses, via the respective mobile devices, of the group of the defined number of different provisioning profiles; and based on a selection of a provisioning profile from the group of the defined number of different provisioning profiles that has been stored in a mobile device of the respective mobile devices, enabling an access of the respective accesses of the network services by the mobile device

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user, e.g., subscriber, desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., a decision tree based learning model, a linear regression based learning model, support vector machines, neural networks, expert systems, Bayesian belief networks, fuzzy logic, and data fusion engines) can be employed in connection with performing automatic and/or inferred action in connection with the disclosed subject matter.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations by the processor, comprising:
generating a group of a defined number of different provisioning profiles that facilitate respective accesses, via respective mobile devices, of network services that have been enabled via a network associated with a network service provider, wherein the different provisioning profiles comprise respective international mobile subscriber identities and respective authentication information;
storing, as a stored group of the defined number of different provisioning profiles, the group of the defined number of different provisioning profiles in a data storage device that is part of the network;
sending the group of the defined number of different provisioning profiles to a device manufacturer device corresponding to a device manufacturer to facilitate storage of the group of the defined number of different provisioning profiles in the respective mobile devices to facilitate respective accesses, via the respective mobile devices, of the group of the defined number of different provisioning profiles; and
based on a selection of a provisioning profile from the group of the defined number of different provisioning profiles that has been stored in a mobile device of the respective mobile devices, enabling an access of the respective accesses of the network services by the mobile device.

2. The system of claim 1, wherein the group of the defined number of different provisioning profiles has been stored in the mobile device during installation of software in the mobile device.

3. The system of claim 1, wherein the provisioning profile has been selected, via an operating system of the mobile device, from the group of the defined number of different provisioning profiles that has been stored in the mobile device, and wherein the provisioning profile comprises an international mobile subscriber identity of the respective international mobile subscriber identities and authentication information of the respective authentication information.

4. The system of claim 3, wherein the provisioning profile has been stored in an embedded subscriber identity module of the mobile device, and wherein the operations further comprise:
receiving, from the mobile device via the embedded subscriber identity module of the mobile device, an attach request to attach to the network to facilitate the access of the respective accesses of the network services by the mobile device, wherein the attach request comprises the provisioning profile comprising the international mobile subscriber identity and the authentication information.

5. The system of claim 4, wherein enabling the access of the respective accesses of the network services by the mobile device comprises:
in response to matching the provisioning profile with a stored provisioning profile of the stored group of the defined number of the different provisioning profiles that have been stored in the data storage device that is part of the network, and
in response to determining that another mobile device that is different from the mobile device is not being attached to the network using the provisioning profile, enabling, using the provisioning profile, the access.

6. The system of claim 4, wherein a first provisioning profile has been randomly selected, via the operating system of the mobile device, from the group of the defined number of different provisioning profiles that has been stored in the mobile device, wherein a first attach request comprising the first provisioning profile that has been received from the mobile device has been rejected, wherein the attach request is a second attach request, and wherein the provisioning profile is a second provisioning profile, different than the first provisioning profile, that has been being randomly selected, via the operating system of the mobile device, in response to a determination that the first attach request comprising the first provisioning profile has been rejected.

7. The system of claim 4, wherein the provisioning profile has been reselected, via the operating system of the mobile device, after a defined delay has been performed by the mobile device in response to a determination, before the defined delay has been performed, that a first attach request comprising the provisioning profile has been rejected, and wherein the attach request is a second attach request.

8. A method, comprising:
storing, by a mobile device comprising a processor, a group of a defined number of different provisioning profiles in a memory device of the mobile device, wherein the different provisioning profiles comprise respective international mobile subscriber identities and respective authentication information, and wherein the different provisioning profiles facilitate respective accesses, via respective mobile devices comprising the mobile device, of network services that have been enabled via a network associated with a network service provider;
in response to selecting, by the mobile device via an operating system of the mobile device, a provisioning profile from the group of the defined number of different provisioning profiles that has been stored in the memory device of the mobile device, sending, by the mobile device, an attach request comprising the provisioning profile to a bootstrap profile system of the network associated with the network service provider; and
in response to the attach request being accepted, receiving, by the mobile device from the bootstrap profile system, an operational profile to facilitate, based on the operational profile, an access, by the mobile device, of the respective accesses of the network services.

9. The method of claim 8, wherein storing the group of the defined number of different provisioning profiles comprises:
storing the group of the defined number of different provisioning profiles in the memory device of the mobile device during an installation of software in the mobile device.

10. The method of claim 8, further comprising:
in response to selecting the provisioning profile, storing, by the mobile device, the provisioning profile in an embedded subscriber identity module, wherein sending the attach request further comprises sending, via the embedded subscriber identity module, the attach request to the bootstrap profile system.

11. The method of claim 8, wherein the attach request is a first attach request, wherein the provisioning profile is a first provisioning profile, and wherein the method further comprises:
in response to the first attach request being determined to be rejected by the bootstrap profile system, randomly selecting, by the mobile device via the operating system of the mobile device, a second provisioning profile, different than the first provisioning profile, from the group of the defined number of different provisioning profiles that has been stored in the memory device of the mobile device; and
sending, by the mobile device, a second attach request comprising the second provisioning profile to the bootstrap profile system.

12. The method of claim 11, further comprising:
in response to the second attach request being accepted by the bootstrap profile system, receiving, by the mobile device from the bootstrap profile system, the operational profile to facilitate, based on the operational profile, the access, by the mobile device, of the respective accesses of the network services.

13. The method of claim 8, wherein the attach request is a first attach request, and wherein the method further comprises:
in response to the first attach request being determined to be rejected by the bootstrap profile system,
performing, by the mobile device, a defined processing delay,
reselecting, by the mobile device via the operating system of the mobile device, the provisioning profile from the group of the defined number of different provisioning profiles that has been stored in the memory device of the mobile device, and
sending, by the mobile device, a second attach request comprising the provisioning profile to the bootstrap profile system.

14. The method of claim 13, further comprising:
in response to the second attach request being accepted by the bootstrap profile system, receiving, by the mobile device from the bootstrap profile system, the operational profile to facilitate, based on the operational profile, the access, by the mobile device, of the respective accesses of the network services.

15. A non-transitory machine-readable medium, comprising executable instructions that, when executed by a system comprising a processor, facilitate performance of operations, comprising:
generating a group of distinct provisioning profiles that facilitate respective accesses, via respective mobile devices, of network services that have been enabled via network equipment that is part of a network;
storing the group of distinct provisioning profiles in a data storage device that is part of the network; and
sending, via an allocation to a device manufacturer, the group of distinct provisioning profiles to a device manufacturer device corresponding to the device manufacturer, wherein the group of distinct provisioning profiles has been stored, based on the allocation to the device manufacturer, in the respective mobile devices to facilitate, based on a selection by a mobile device of the respective mobile devices of a provisioning profile from the group of distinct provisioning profiles that has been stored in the mobile device, an access of the respective access of the network services, enabled via the network, by the mobile device.

16. The non-transitory machine-readable medium of claim 15, wherein the operations further comprise:
receiving an attach request from the mobile device, wherein the attach request comprises the provisioning profile, and wherein the provisioning profile comprises an international mobile subscriber identity and authentication information; and
in response to matching, based on the international mobile subscriber identity and the authentication information, the provisioning profile with a stored provisioning profile of the group of distinct provisioning profiles that has been stored in the data storage device that is part of the network, enabling the access of the respective accesses of the network services.

17. The non-transitory machine-readable medium of claim 15, wherein the selection of the provisioning profile is an arbitrary selection of the provisioning profile from the group of distinct provisioning profiles that has been stored in the mobile device.

18. The non-transitory machine-readable medium of claim 15, wherein a first selection of a first provisioning profile from the group of distinct provisioning profiles has been performed by the mobile device, wherein the provisioning profile is a second provisioning profile that is different from the first provisioning profile, and wherein the selection is a second selection of the second provisioning profile that has been performed by the mobile device in response to an attach request that that has been received from the mobile device and that comprises the first provisioning profile being rejected.

19. The non-transitory machine-readable medium of claim 18, wherein the attach request is a first attach request, and wherein the operations further comprise:
receiving a second attach request from the mobile device, wherein the second attach request comprises the second provisioning profile, and wherein the second provisioning profile comprises an international mobile subscriber identity and authentication information; and
in response to matching, based on the international mobile subscriber identity and the authentication information, the second provisioning profile with a stored provisioning profile of the group of distinct provisioning profiles that has been stored in the data storage device that is part of the network, enabling the access of the respective accesses of the network services.

20. The non-transitory machine-readable medium of claim 15, wherein a first selection of the provisioning profile from the group of distinct provisioning profiles has been performed by the mobile device, wherein the selection is a second selection of the provisioning profile that has been performed by the mobile device, after a defined delay with respect to the first selection of the provisioning profile, in response to an attach request that that has been received from the mobile device and that comprises the provisioning profile being rejected.
